(19) United States
(12) Patent Application Publication
(10) Pub. No.: US 2026/0310671 A1
(43) Pub. Date: Oct. 8, 2026

(54) LEARNING TO PAGE IN AND PAGE OUT DATA CHUNKS IN A GENERATIVE NEURAL NETWORK

(71) Applicant: GDM Holding LLC, Mountain View, CA (US)

(72) Inventors: Florian Nils Hartmann, Zurich (CH); Matthew Sharifi, Kilchberg (CH)

(21) Appl. No.: 19/172,529

(22) Filed: Apr. 7, 2025

(51) Int. Cl. G06F 16/2455; G06N 3/0475; G06N 3/092

(52) U.S. Cl. CPC G06F 16/24553

(57) ABSTRACT

Methods, systems, and apparatus for using paging operations in a generative neural network at inference. In one aspect, a user query is received. Data chunks for the user query from respective data sources are retrieved. Descriptive paths for data chunks included in each data source are retrieved. A context block for the user query is initialized by adding the data chunks for the user query and the descriptive paths to the context block. An initial input including the user query and the initialized context block is processed using the generative neural network to generate an initial output that includes data specifying paging operations that each reference one or more of the descriptive paths. The context block is updated by executing the paging operations. An updated input that includes the updated context block is processed using the generative neural network to generate a final response to the user query.

### BACKGROUND

This specification generally relates to performing retrieval-augmented generation (RAG) using a generative neural network.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

Generative neural networks are machine learning models that are configured, through training, to perform a generative task to generate, as output, data that includes, for example, text data, image data, video data, audio data, or multimodal data that includes data in two or more different modalities. Example generative tasks include text generation, image synthesis, audio generation, video generation, code generation, or style transfer.

### SUMMARY

This specification describes systems and methods for learning to page-in and page-out data chunks in a generative neural network.

In general, one innovative aspect of the subject matter described in this specification may be embodied in methods that include the actions of receiving a user query; retrieving multiple data chunks for the user query, wherein each data chunk for the user query comprises data from a respective data source; retrieving, for each respective data source, descriptive paths for a plurality of data chunks included in the respective data source, wherein the data chunks included in the respective data source comprise one or more of the multiple data chunks for the user query and one or more other data chunks; initializing a context block for the user query, comprising adding the multiple data chunks for the user query and the descriptive paths for the data chunks included in the respective data sources to the context block; processing an initial input comprising the user query and the initialized context block using a generative neural network to generate an initial output that comprises data specifying one or more paging operations that each update one or more data chunks included in the context block and that each reference one or more of the descriptive paths; updating the context block by executing the one or more paging operations; processing an updated input that includes the updated context block using the generative neural network to generate a final response to the user query; and outputting the final response to the user query.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus (e.g., one or more computers or computer processors), cause the apparatus to perform the actions.

The foregoing and other embodiments can each optionally include one or more of the following features, alone or in combination. In some implementations processing the updated input that includes the updated context block using the generative neural network to generate a final response to the user query comprises performing one or more additional updates of the context block by executing the one or more paging operations.

In some implementations the one or more paging operations comprise a page-in operation that adds an additional data chunk into the context block, wherein the page-in operation is parameterized by a descriptive path for the data chunk.

In some implementations the initial input to the generative neural network comprises a reasoning prompt that causes the generative neural network to include the data specifying the one or more paging operations.

In some implementations the one or more paging operations comprise a page-out operation that removes a data chunk from the context block, wherein the page-out operation is parameterized by a descriptive path for the data chunk.

In some implementations the descriptive paths for the plurality of data chunks included in the respective data source comprise descriptive paths for each data chunk included in the respective data source.

In some implementations the descriptive paths for the plurality of data chunks included in the respective data source comprise descriptive paths for a strict subset of data chunks included in the respective data source.

In some implementations the one or more paging operations comprise an expand operation that is parameterized by a descriptive path for a data chunk, wherein execution of the expand operation outputs candidate continuations of the descriptive path.

In some implementations the one or more paging operations comprise a toggle operation that is parameterized by a descriptive path for a data chunk, wherein execution of the toggle operation removes content of the data chunk from the context block and retains a description of the data chunk in the descriptive path.

In some implementations retrieving the multiple data chunks for the user query comprises retrieving data chunks that are semantically similar to or aligned with the user query.

In some implementations descriptive paths for a plurality of data chunks included in a respective data source specify a hierarchical structure of the respective data source.

In some implementations a descriptive path for a data chunk included in a respective data source comprises a navigation path for the data chunk and a description of the data chunk, wherein a number of tokens included in the description of the data chunk is less than a number of tokens included in the data chunk.

In some implementations each descriptive path for a data chunk included in a respective data source is a unique descriptive path.

In some implementations the method further comprises maintaining, during the processing of the initial input and updated input, a transcript of executed paging operations; and removing, based on the transcript of executed paging operations and from the context block, descriptive paths that lead to loops of paging operations or descriptive paths that have been used to execute a page-in operation.

In some implementations the method further comprises maintaining, during the processing of the initial input and updated input, a transcript of executed paging operations; and bypassing execution of output paging operations that reference descriptive paths that lead to loops of paging operations or descriptive paths that have been used to execute a page-in operation.

In some implementations the method further comprises training the generative neural network using reinforcement learning on labeled training data to utilize the one or more paging operations when processing a user query and context block, wherein the generative neural network is trained to maximize a reward that comprises utility and computational efficiency.

In some implementations computational efficiency is measured using one or more of: a number of tokens included in the context block or a number of utilized paging operations.

In some implementations the method further comprises training the generative neural network to utilize the one or more paging operations when processing a user query and context block using curriculum learning on a set of training examples, wherein the training examples in the set are ordered with increasing complexity.

Some implementations of the subject matter described herein may realize, in certain instances, one or more of the following advantages.

Generative neural networks such as large language models can answer knowledge-related questions using a knowledge base. This can be achieved using a retrieval-augmented generation (RAG) system, where data sources are split into data chunks and indexed in a database. When a user queries the generative neural network, data chunks that are relevant to the user query are retrieved from the database and added as a context block to an input to the generative neural network, along with the original user query. This allows users to pose queries for which relevant content is automatically retrieved, rather than the user needing to provide this content explicitly.

Increasing the size of the context block allows for more data chunks to be included in the input to the generative neural network. However, using a larger context block comes at a higher computational cost and higher latency. Additionally, context block size is still a limiting factor when it comes to handling very large repositories of information, e.g., collections of research articles, an encyclopedia, etc. Further, it is not always possible to determine a-priori what content is most relevant to a user query. Initial RAG vector searches may not be accurate.

Examples of the presently described methods and systems address this technical problem and provide additional technical advantages. For example, the presently described methods and systems enable generative neural network models to dynamically page in and page out data chunks from a given document or set of documents based on what information is actually useful to them. This allows the models to explore and consume different kinds of content, which improves the model's ability to find relevant information in large corpora. In addition, removing irrelevant content from the context block results in more efficient use of the context block, which reduces computational cost (e.g., the compute cost and the amount of required memory) and latency. In addition, computational cost and latency can be further reduced by avoiding loops of paging operations or redundant content exploration.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a conceptual diagram of a generative neural network system that dynamically adjusts a generative neural network context block using paging operations.

FIG. 2 is a block diagram of an example generative neural network system.

FIG. 3 is a block diagram of operations performed by the data chunking and embedding system of FIG. 2 during an example process for generating data chunks and corresponding descriptive paths.

FIG. 4 is a block diagram of the example system of FIG. 2 during an example process for using paging operations in a generative neural network at inference.

FIG. 5 is a flow chart of an example process for using paging operations in a generative neural network at inference.

Like reference symbols in the various drawings indicate like elements.

### DETAILED DESCRIPTION

This specification describes systems and methods that enable generative neural networks to dynamically page in and page out RAG data chunks from a given document or set of documents. This allows the generative neural networks to explore and consume different kinds of context content, e.g., by paging the content in, and to remove context content that is not believed to be useful, e.g., by paging the content out. This enables more efficient use of the context block, reduces computational cost and latency, and improves the ability of generative neural networks to find required information in large corpora.

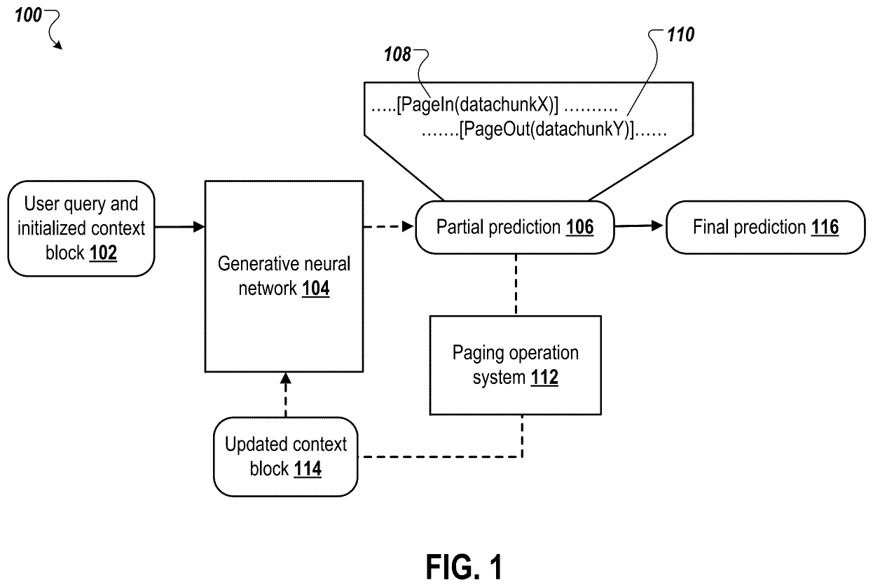

FIG. 1 is a conceptual diagram 100 of a generative neural network system that dynamically adjusts a generative neural network context block using paging operations.

A user queries the generative neural network system. The query is encoded and added to an initial input 102 for a generative neural network 104. Multiple data chunks that are semantically similar to or aligned with the query are retrieved from a database. The retrieved data chunks are combined to form a context block which is added to the initial input 102.

The generative neural network 104 processes the initial input 102 and starts outputting tokens in a partial prediction 106. The generative neural network 104 has been configured to dynamically adjust the context block during the decoding of the initial input 102 based on whether the current information included in the context block is useful for the decoding or not. For example, the generative neural network 104 can call a page in operation 108 to add one or more data chunks to the context block if the one or more data chunks are predicted to be useful for the decoding. Similarly, the generative neural network 104 can call a page out operation 110 to remove one or more data chunks from the context block if the one or more data chunks are not predicted to be useful for the decoding. To call an operation, the generative neural network 104 includes a corresponding sequence of tokens in the output that identifies the operation and parameters for the call. The sequence of tokens can be delimited by predetermined tokens or markers that distinguish the call from the rest of the output.

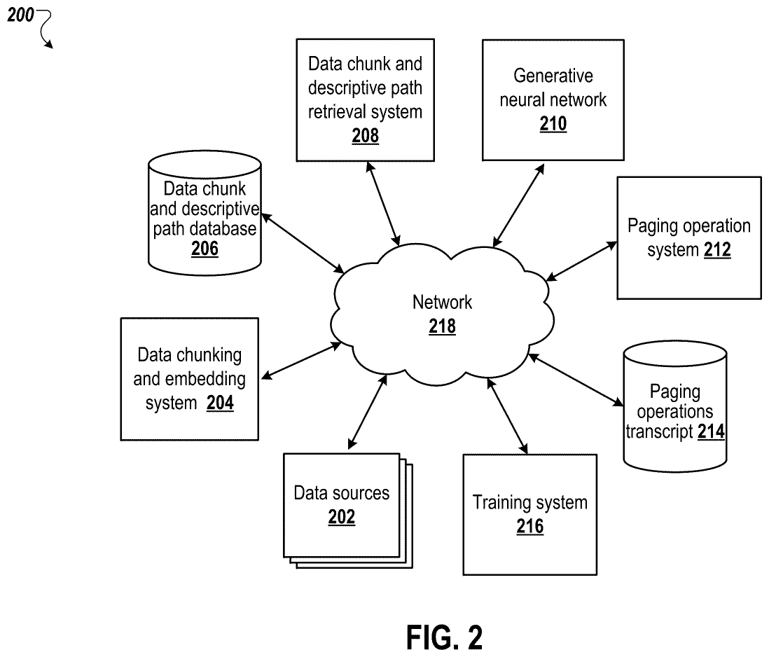

During the decoding of the initial input 102, a paging operation system 112 monitors the tokens that are being output in the partial prediction 106. When the paging operation system 112 detects that the generative neural network 104 has called a paging operation, the paging operation is executed accordingly. For example, if the generative neural network 104 calls a page in operation, a corresponding data chunk is added to the context block. As another example, if the generative neural network 104 calls a page out operation, a corresponding data chunk is removed from the context block. Other paging examples are described in more detail below, e.g., with reference to FIGS. 2-5.

The resulting updated context block 114 can then be provided to the generative neural network 104 for use in the decoding. The context block can be iteratively adjusted in this manner (as indicated by the dashed lines) until the generative neural network 104 has explored and consumed enough information to output a final prediction 116. The final prediction 116 can then be returned to the user.

FIG. 2 is a block diagram of an example generative neural network system 200. The example system 200 is an example of a system implemented as computer programs on one or more computers in one or more locations, in which the systems, components, and techniques described herein can be implemented. The example system 200 includes multiple data sources 202, a data chunking and embedding system 204, a data chunk and descriptive path database 206, a data chunk and descriptive path retrieval system 208, a generative neural network 210, a paging operation system 212, a paging operations transcript 214, and a training system 216. The components of the example system 200 can be connected via a network 218, e.g., a local area network (LAN), wide area network (WLAN), the Internet, or a combination thereof, which can be accessed over a wired and/or a wireless communications link.

The multiple data sources 202 are data sources used by the system 200 to generate data chunks that can be included in a context block for the generative neural network 210. The data sources can include structured data sources, e.g., knowledge bases or databases, unstructured data sources, e.g., unstructured text documents including reports, articles, research papers, etc., web content, e.g., scraped or curated content from websites, user generated content, e.g., emails, chats, or user feedback, and domain specific resources, e.g., medical literature or legal documents.

The data chunking and embedding system 204 is configured to divide text included in the multiple data sources 202 into smaller data chunks. For example, the data chunking and embedding system 204 can be configured to implement a chunking method, e.g., recursive character text splitting, document-specific splitting, semantic chunking, or agentic chunking, to generate the data chunks. In some implementations the data chunks generated by the data chunking and embedding system 204 can have a predetermined maximum size, e.g., where the size is determined based on the size of the generative neural network context block.

The data chunking and embedding system 204 is further configured to generate unique descriptive paths for the data chunks. A descriptive path for a data chunk specifies a hierarchical structure of the data source from which the data chunk originates. For example, the descriptive path can include a breadcrumb navigation path that shows the location of the data chunk within the data source and a short title or description that describes the content of the data chunk. A breadcrumb navigation path for a data chunk in a data source is a textual representation of the hierarchical structure of the data source. The breadcrumb path specifies a path from a top-level node of the data source, e.g., a website home page, to a lower-level node that includes the data chunk, e.g., a section header of an article within the website. An example breadcrumb navigation path for a data chunk describing a specific aspect of a topic (e.g., Barack Obama's early legal career) is described in more detail below.

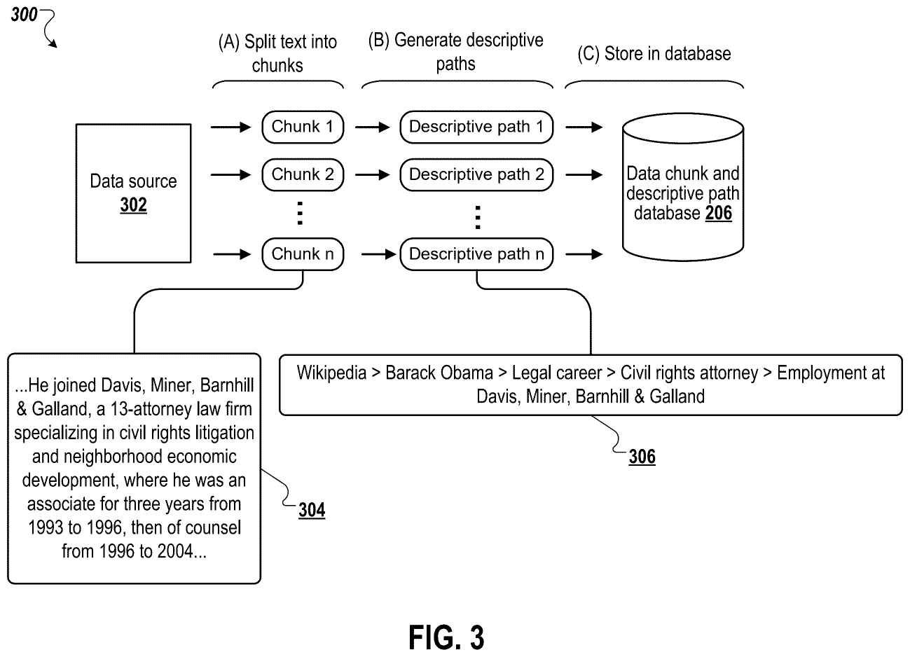

In some implementations, the data chunking and embedding system 204 can generate the descriptive paths for the data chunks based on the inherent structure of the multiple data sources 202. Alternatively or in addition, the data chunking and embedding system 204 can include a generative neural network, e.g., large language model, that has been trained to generate descriptive paths for data chunks included in a respective data source. Example operations performed by the data chunking and embedding system 204 are described in more detail below with reference to FIG. 3.

The data chunking and embedding system 204 is further configured to generate embeddings for the data chunks. An embedding is an ordered collection of numerical values, e.g., a vector of floating point or other numerical values. The data chunking and embedding system 204 can generate the embeddings for the data chunks using an embedding model, e.g., a Transformer or specialized embedding model such as a sentence Transformer. The embedding model can be trained to output fixed-size vector embeddings of input data chunks using an objective function, e.g., a contrastive loss that encourages embeddings of similar data chunks to be close and embeddings of dissimilar data chunks to be far apart or a classification loss that trains the model to produce embeddings that allow effective classification of relationships between data chunks.

The data chunks, embeddings for the data chunks, and the descriptive paths for the data chunks are stored in the data chunk and descriptive path database 206.

The data chunk and descriptive path retrieval system 208 is configured to query the data chunk and descriptive path database 206 to retrieve data chunks and add the retrieved data chunks to a context block for the generative neural network 210. For example, when the system 200 receives a query from a user, the data chunk and descriptive path retrieval system 208 can use an embedding of the user query to identify data chunks in the data chunk and descriptive path database 206 that are relevant to the user query, e.g., by identifying embeddings of data chunks stored in the data chunk and descriptive path database 206 that are similar to the embedding of the user query. Embeddings can be determined to be similar if a distance between two embeddings, e.g., a cosine similarity, Euclidean distance, Manhattan distance, or dot product, is less than a predetermined threshold.

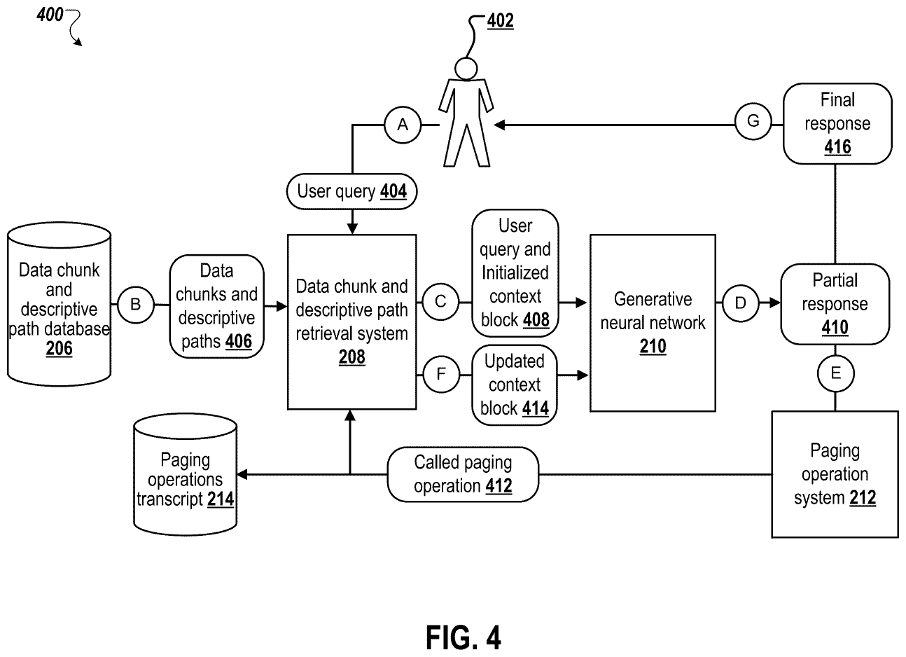

The data chunk and descriptive path retrieval system 208 can then retrieve the data chunks that are relevant to the user query (referred to as relevant data chunks) and descriptive paths for the relevant data chunks from the data chunk and descriptive path database 206. The data chunk and descriptive path retrieval system 208 also proactively retrieves descriptive paths of other data chunks included in the data sources from which the relevant data chunks originate from in order to obtain a hierarchy of the data sources, as described in more detail below with reference to FIG. 4. The data chunk and descriptive path retrieval system 208 can then add, e.g., concatenate, the relevant data chunks and descriptive paths to the user query to generate an initial context block for the user query.

After the initial context block for the user query has been input to the generative neural network 210 and the generative neural network 210 has begun to output a partial response to the user query, the data chunk and descriptive path retrieval system 208 can receive a request from the paging operation system 212 to perform a paging operation on a data chunk included in the context block for the user query. The data chunk and descriptive path retrieval system 208 can then execute the paging operation to adjust the context block, e.g., remove a data chunk and descriptive paths corresponding to the data chunk from the context block, retrieve a new data chunk from the data chunk and descriptive path database 206 and add the new chunk to the context block, retrieve an expansion of a descriptive path from the data chunk and descriptive path database 206 and add the expanded descriptive path to the context block, or remove a data chunk (but retain descriptive paths corresponding to the data chunk) from the context block. The chunk and descriptive path retrieval system 208 can then provide the adjusted context block to the generative neural network 210.

The generative neural network 210 is a machine learning model that is configured to receive a context block as input. The context block is an input sequence of tokens that includes a prompt, e.g., a query input by a user. The prompt can be a question, statement, or other form of textual input. The context block also includes one or more data chunks that are relevant to the prompt and descriptive paths for the relevant data chunks. The context block also includes descriptive paths for some or all other data chunks included in data sources from which the relevant data chunks originate, as described above.

The generative neural network 210 is configured, through training, to process the context block by analyzing the semantic and syntactic relationships between words or phrases included in the context block and uses learned patterns to generate an output sequence of tokens that represents a response to the prompt. The generative neural network 210 is an auto-regressive neural network that generates each particular token in the output sequence conditioned on a current input sequence that includes an input sequence included in the network input and any tokens that precede the particular token in the output sequence, i.e., the tokens that have already been generated for any previous positions in the output sequence that precede the particular position of the particular token.

As a particular example, the generative neural network 210 can have any of a variety of Transformer-based neural network architectures, e.g., encoder-only Transformer architectures, encoder-decoder Transformer architectures, decoder-only Transformer architectures, diffusion Transformer architectures, other attention-based architectures, and so on.

Examples of such Transformer-based neural network architectures include those described in Colin Raffel, et al., Exploring the limits of transfer learning with a unified text-to-text transformer. arXiv preprint arXiv:1910.10683, 2019; Daniel Adiwardana, et al., Towards a human-like open-domain chatbot. CoRR, abs/2001.09977, 2020; Aakanksha Chowdhery, et al., PaLM: Scaling Language Modeling with Pathways, arXiv preprint arXiv:2204.02311; Rohan Anil, et al., Palm 2 technical report. arXiv preprint arXiv:2305.10403, 2023; and Gemini Team, et al., Gemini: a family of highly capable multimodal models. arXiv preprint arXiv:2312.11805 (2023).

For example, the generative neural network 210 may be a language model neural network. Examples of generative language model neural networks include Sparrow (Glaese, et al., arXiv:2209.14375), Chinchilla (Hoffmann, et al., arXiv:2203.15556), and PaLM 2 (Anil, et al., arXiv:2305:10403).

As another example, the generative neural network 210 may be a multi-modal model neural network, e.g., a vision language model (VLM) neural network. Examples of multi-modal neural networks include Flamingo (Alayrac, et al., arXiv:2204.14198), PaLI (Chen, et al., arXiv:2209.06794), and PaLI-X (Chen, et al., arXiv:2305.18565).

As another example, the generative neural network 210 may be a foundation model neural network. A foundation model neural network is a large-scale machine learning model trained on a broad data set that can be adapted and fine-tuned for a wide variety of applications and downstream tasks. Examples of foundation model neural networks include Imagen (Saharia, et al., arXiv:2205.11487) and Parti (Yu, et al., arXiv:2206.10789).

The generative neural network 210 can include an input block, followed by one or more intermediate blocks, followed by an output block. The input block can receive an input to the generative neural network 210.

The input block can include an embedding layer. The embedding layer includes parameters that represent elements of an embedding matrix which can be used to map each token in the vocabulary of tokens into a corresponding embedding of the token.

The one or more intermediate blocks can include one or more attention blocks, e.g., one or more local attention blocks, one or more global attention blocks, or both. A local attention block is a block that includes a local attention mechanism, while a global attention block is a block that includes a global attention mechanism.

The output block can generate an output of the generative neural network 210. For example, the output can include a score distribution, e.g., a probability distribution, over tokens in a vocabulary of tokens. The score distribution assigns a respective score, e.g., a respective probability, to each token in the vocabulary of tokens.

The output block can include a de-embedding layer. The de-embedding layer includes parameters that represent elements of a de-embedding matrix which can be used to map an embedding to a corresponding token in the vocabulary of tokens. In some implementations, the de-embedding matrix can be a transpose of the embedding matrix included in the input block, such that each parameter of the de-embedding matrix has a corresponding parameter in the embedding matrix.

The vocabulary of tokens can include any of a variety of tokens that represent text symbols or other symbols. For example, the vocabulary of tokens can include one or more of: characters, sub-words, words, punctuation marks, numbers, or other symbols that appear in a corpus of natural language text and/or computer code.

The generative neural network 210 is also configured to utilize one or more of the above described paging operations during decoding to dynamically adjust data chunks included in the input context block, e.g., explore additional content by paging the content into the context block. Calls to the paging operations are embedded in the generative neural network output, e.g., delimited by special tokens. An example call to a page in operation can be embedded in the generative neural network output as [PageIn( )], where the tokens “[” and “]” are the delimiting special tokens. The special tokens are included in the generative neural network's vocabulary.

The paging operation system 212 is configured to monitor outputs generated by the generative neural network 210 to detect calls to paging operations. When the paging operation system 212 detects, within the output of the generative neural network, tokens representing a call to a paging operation, the paging operation system 212 is configured to instruct the data chunk and descriptive path retrieval system 208 to execute the paging call and adjust the context block, as described above. In addition, the paging operation system 212 is configured to add the call to the paging operation to the paging operations transcript 214. The paging operations transcript 214 maintains a record of paging operations called by the generative neural network 210. In some implementations, the record of paging operations can be used by the training system 216 during training of the generative neural network 210.

In addition, in some implementations the system 200 can be configured to use the record of paging operations in the paging operations transcript 214 to identify descriptive paths that lead to loops of calls of paging operations or descriptive paths that have already been used to execute a page-in operation. The system 200 can then take actions to avoid decoding loops or redundant processing, e.g., by actively removing the identified descriptive paths from the context block or by ignoring page in calls output by the generative neural network 210 that are parameterized by the identified descriptive paths. For example, the record of paging operations can be used to identify data chunks that the generative neural network 210 has previously paged in and paged out, e.g., multiple times. Then, if the generative neural network 210 calls to page in or page out the data chunk again, the system 200 can ignore the call and/or remove the corresponding descriptive path from the context block. In some implementations the generative neural network 210 can be taught during training to avoid loops of paging operations.

In some implementations the generative neural network 210 can be instructed how to utilize the paging operations during decoding, e.g., using few-shot prompting. In other implementations the generative neural network 210 can be trained to utilize the paging operations during decoding. In these implementations, the system 200 can include a training system 216 that is configured to train the generative neural network 210 to utilize the paging operations during decoding. In some implementations the training system 216 can apply reinforcement learning techniques to train the generative neural network 210. For example, the training system 216 can provide the generative neural network 210 with an input (context block) from a labelled dataset of training examples. The generative neural network 210 processes the input, using the paging operations as necessary, to obtain a predicted output. The training system 216 then trains the generative neural network 210 to maximize a reward for the predicted output. In some implementations the reward can be based on utility, e.g., where a higher utility indicates that the predicted output is correct and/or aligned with human preferences. Alternatively or in addition, the reward can be based on efficiency, e.g., where a higher efficiency indicates that the generative neural network 210 generated the predicted output without requiring a large amount of context. Efficiency can be measured by, e.g., a number of tokens used to generate the predicted output and/or a number of called paging operations. The reward therefore teaches the generative neural network 210 to effectively explore data sources without utilizing too much context (or paging operations).

In some implementations, the training system 216 can be configured to train the generative neural network 210 using a curriculum style, where the training examples provided to the generative neural network 210 gradually increase in difficulty. For example, at the beginning of training the generative neural network 210 can be provided with a context block that includes a large proportion of relevant data chunks. In these examples, the generative neural network 210 may only be required to call the page in operation a small number of times, e.g., 1-2 times, to explore 1-2 additional data chunks to generate the predicted output. In the middle of training, the generative neural network 210 can be provided with an empty context block (a context block that only includes a user query) or a context block that has been initialized using standard techniques (and includes multiple data chunks). In these examples, the generative neural network 210 may be required to call multiple paging operations several times, e.g., to explore additional data chunks and remove consumed data chunks in order to maintain the context block size. Towards the end of training, the generative neural network 210 can be provided with a purposefully irrelevant context block or a context block that includes confusing data chunks. In these examples, the generative neural network 210 may be required to call the page out operation several times in order to remove the irrelevant or confusing data chunks.

FIG. 3 is a block diagram 300 of operations performed by the data chunking and embedding system 204 of FIG. 2 during an example process for generating data chunks and corresponding descriptive paths. The block diagram 300 illustrates the example process as including stages (A)-(C). However, in some implementations the process can include fewer or more stages.

During stage (A) of the example process, text in a data source 302 is split into multiple data chunks. For example, in the example shown in FIG. 3, the data source could be the Wikipedia article for Barack Obama. In this example, the data chunks could correspond to paragraphs (or portions of paragraphs if the paragraphs exceed a predetermined maximum token limit) included in the Wikipedia article, e.g., data chunk 304.

During stage (B) of the example process, a descriptive path is generated for each data chunk. Each descriptive path can be generated as a navigation path that specifies the location of the corresponding data chunk in the data source 302 and can include a short description or title that describes the content of the data chunk. Each descriptive path is therefore unique. For example, in the example shown in FIG. 3, the descriptive path 306 for the data chunk 304 is given by “Wikipedia>Barack Obama>Legal career>Civil rights attorney>Employment at Davis, Miner, Barnhill & Galland.” That is, the descriptive path 306 includes a breadcrumb navigation path “Wikipedia>Barack Obama>Legal career>Civil rights attorney” that specifies the location of the data chunk and a description “Employment at Davis, Miner, Barnhill & Galland” of the data chunk. The descriptive paths generated during stage (B) encode the hierarchical information of the data source 302. In implementations where there is no hierarchical information, the descriptive path could include the document name followed by a short description that describes the content of the data chunk.

During stage (C) of the example process, embeddings of the data chunks generated during stage (A) are generated and the data chunks, embeddings of the data chunks, and descriptive paths generated during stage (B) are stored in the data chunk and descriptive path database 206.

FIG. 4 is a block diagram 400 of the example system 200 of FIG. 2 during an example process for using paging operations in a generative neural network at inference. The block diagram 400 illustrates the example process as including stages (A)-(G). However, in some implementations the process can include fewer or more stages.

During stage (A) of the example process, a user 402 provides a user query 404. During stage (B), the data chunk and descriptive path retrieval system 208 retrieves data chunks and descriptive paths 406 for the user query from the data chunk and descriptive path database 206. The data chunks are data chunks that are relevant to the user query, e.g., semantically similar to the user query. For example, the data chunk and descriptive path retrieval system 208 can generate an embedding of the user query and perform a similarity search between the embedding of the user query and pre-computed embeddings of data chunks stored in the data chunk and descriptive path database 206 to identify data chunks that are relevant to the user query, e.g., based on a similarity metric such as cosine similarity, Euclidean distance, Manhattan distance, or dot product. The data chunk and descriptive path retrieval system 208 can then retrieve the data chunks that are relevant to the user query and corresponding descriptive paths.

The descriptive paths include a descriptive path of each data chunk, e.g., a navigation path followed by a short title describing the content of the data chunk, as described above with reference to FIG. 3. The descriptive paths also include descriptive paths of (e.g., all) other data chunks included in the data sources from which the relevant data chunks originate from. In this manner, the descriptive paths included in the data chunks and descriptive paths 406 can provide a (e.g., full) hierarchy of each data source from which one or more relevant data chunks originate from. For example, if the system were to retrieve data chunk 304 described above with reference to FIG. 3, the system would also retrieve the descriptive path 306 for the data chunk 304 as well as descriptive paths of other data chunks included in the Wikipedia article for Barack Obama.

During stage (C) of the example process, the data chunk and descriptive path retrieval system 208 generates an initial context block using the data chunks and descriptive paths 406 and provides the user query and initial context block 408 to the generative neural network 210. During stage (D), the generative neural network 210 processes the user query and initial context block 408 and begins decoding tokens to generate a partial response 410 to the user query 404. During the decoding, the generative neural network 210 calls one or more paging operations that update the content included in the context block. For example, the generative neural network 210 can explore additional content by calling the page in operation. Further, instead of keeping all content in the context block, the generative neural network 210 can remove irrelevant or consumed content from the context block by calling the page out operation.

During stage (E), the paging operation system 212 monitors the text output in the partial response 410. When the paging operation system 212 detects that the generative neural network 210 has called a paging operation, the paging operation system 212 provides the called paging operation 412 to the data chunk and descriptive path retrieval system 208. In response, the data chunk and descriptive path retrieval system 208 executes the called paging operation 412 to generate an updated context block 414. For example, in implementations where the generative neural network 210 calls a page in operation that is parameterized by a descriptive path included in the current context block, the data chunk and descriptive path retrieval system 208 can execute the page in operation to retrieve a data chunk from the data chunk and descriptive path database 206 that corresponds to the descriptive path. The data chunk can then be added to the current context block to generate an updated context block 414. As another example, in implementations where the generative neural network 210 calls a page out operation that is parameterized by a descriptive path included in the current context block, the data chunk and descriptive path retrieval system 208 can execute the page out operation to remove a data chunk that corresponds to the descriptive path from the current context block. Also during stage (E), the called paging operation 412 is added to the paging operations transcript 214.

During stage (F), the updated context block 414 is provided as input to the generative neural network 210. The generative neural network 210 then continues the decoding using the updated context block 414. For example, the generative neural network 210 can access a key-value cache that stores activations from generation steps prior to the update to the context block. The generative neural network 210 can then re-use parts of the cache for portions of the updated context block that have stayed the same and compute activations for portions of the updated context block that are new.

Stages (D)-(F) can be iteratively performed, e.g., until the generative neural network 210 obtains the content it requires to generate a final response 416, e.g., which is implied by a sequence that does not include calls to paging operations and ends with an EOS token. During stage (G), the final response 416 is returned to the user 402.

In some implementations, during stage (B) of the example process, the data chunk and descriptive path retrieval system 208 can retrieve descriptive paths for the data chunks that are relevant to the user query and a subset of the descriptive paths for other data chunks included in the data sources from which the relevant data chunks originate from, e.g., descriptive paths of top-level headings in a data source. In this manner, the descriptive paths included in the data chunks and descriptive paths 406 do not provide a full hierarchy of each data source from which one or more relevant data chunks originate from. Instead, the descriptive paths included in the data chunks and descriptive paths 406 provide a list of possible expansions of each data source from which one or more relevant data chunks originate from. In these implementations, during stage (D) and (E), the paging operations called by the generative neural network 210 can include an expand operation that is parameterized by a descriptive path and outputs possible continuations of the descriptive path and a toggle operation that is parameterized by a descriptive path and removes content of the data chunk referred to by the descriptive path (but retains a short description of the data chunk). In these implementations, the number of required context tokens can be reduced since the context block does not include a full hierarchy of the relevant data sources. However, the generative neural network 210 must be taught to use the two additional paging operations during training, and use of the additional paging operations during inference can result in more tool calls being performed.

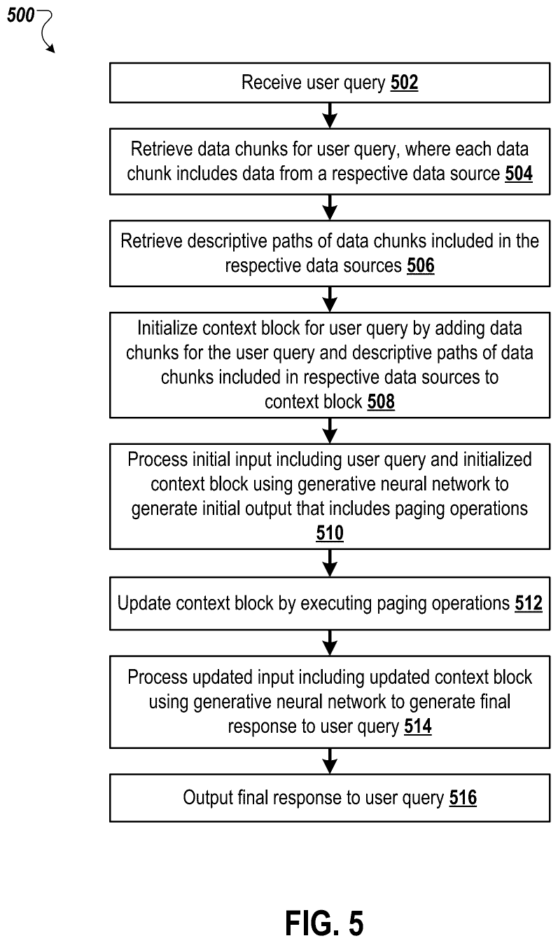

FIG. 5 is a flow chart of an example process 500 for using paging operations in a generative neural network at inference. For convenience, the process 500 will be described as being performed by a system of one or more computers located in one or more locations. For example, a generative neural network system, e.g., the system 200 of FIG. 2, appropriately programmed, can perform example process 500.

The system receives a user query (step 502). The system retrieves multiple data chunks for the user query (step 504). Each data chunk for the user query is semantically similar to or aligned with the user query and includes data from a respective data source, e.g., a knowledge base or database, text document, web content, or domain specific resource.

For each respective data source, the system retrieves descriptive paths for multiple data chunks included in the respective data source (step 506). Each descriptive path includes a unique navigation path that specifies a location of the corresponding data chunk in the respective data source. Each descriptive path also includes a description of the data chunk (where the number of tokens included in the description of the data chunk is less than the number of tokens included in the data chunk itself). The descriptive paths for data chunks included in a respective data source therefore specify a hierarchical structure of the data source, e.g., in terms of section breaks and headers.

The data chunks included in the respective data source include one or more of the multiple data chunks for the user query and one or more other data chunks. That is, in some implementations the system can retrieve descriptive paths for each data chunk included in the respective data source (the data chunks determined to be semantically similar to or aligned with the user query and all other data chunks in the respective data source). In other implementations the system can retrieve descriptive paths for a strict subset of data chunks included in the respective data source (the data chunks determined to be semantically similar to or aligned with the user query and optionally one or more other data chunks in the respective data source).

The system initializes a context block for the user query (step 508). The system adds the multiple data chunks for the user query and the descriptive paths for the data chunks included in the respective data sources to the context block.

The system processes an initial input that includes the user query and the initial context block using a generative neural network to generate an initial output that includes data specifying one or more paging operations that each update one or more data chunks included in the context block and that each reference one or more of the descriptive paths (step 510). The one or more paging operations can include a page-in operation that adds an additional data chunk into the context block, where the page-in operation is parameterized by a descriptive path for the data chunk. Further, the one or more paging operations can include a page-out operation that removes a data chunk from the context block, where the page-out operation is parameterized by a descriptive path for the data chunk.

In addition, in some implementations (e.g., implementations where the system retrieves descriptive paths for a strict subset of data chunks included in the respective data source at step 506), the one or more paging operations can include an expand operation that is parameterized by a descriptive path for a data chunk, where execution of the expand operation outputs candidate continuations of the descriptive path. The one or more paging operations can also include a toggle operation that is parameterized by a descriptive path for a data chunk, where execution of the toggle operation removes content of the data chunk from the context block and retains a description of the data chunk in the descriptive path.

In some implementations the initial input that is processed by the generative neural network can include a reasoning prompt that enables the generative neural network to perform chain of thought reasoning and causes the generative neural network to include the data specifying the one or more paging operations.

The system updates the context block by executing the one or more paging operations (step 512). The system then processes an updated input that includes the updated context block using the generative neural network to generate a final response to the user query (step 514). In some implementations, the system can perform one or more additional updates to the context block before the final response to the user query is generated. That is, the system can iteratively perform steps 510-514 until the final response to the user query is generated, e.g., until a sequence of tokens that does not include a call to a paging operation and ends with a predetermined end-of-sequence token is output. The system outputs the final response to the user query (step 516).

In some implementations the system can maintain a transcript of the paging operations executed at step 512 (and any subsequent iterations of step 512). In these implementations, the system can provide the transcript of the paging operations for use in training or fine tuning the generative neural network. For example, as described above with reference to FIG. 2, in some implementations the system can train the generative neural network using reinforcement learning on labeled training data to utilize the one or more paging operations when processing a user query and context block. In these implementations the generative neural network can be trained to maximize a reward that combines utility and computational efficiency, where computational efficiency is measured using one or more of: a number of tokens included in the context block or a number of utilized paging operations. The training can include curriculum learning on a set of training examples that are ordered with increasing complexity.

Further, in some implementations the system can use the transcript of the paging operations to remove descriptive paths that lead to loops of paging operations or descriptive paths that have already been used to execute a page-in operation from the current context block. Alternatively or in addition, the system can use the transcript of the paging operations to bypass execution of output paging operations that reference descriptive paths that lead to loops of paging operations or descriptive paths that have been used to execute a page-in operation (i.e., treat the paging operations as no-operations).

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A computer implemented method comprising:
receiving a user query;
retrieving multiple data chunks for the user query, wherein each data chunk for the user query comprises data from a respective data source;
retrieving, for each respective data source, descriptive paths for a plurality of data chunks included in the respective data source, wherein the data chunks included in the respective data source comprise one or more of the multiple data chunks for the user query and one or more other data chunks;
initializing a context block for the user query, comprising adding the multiple data chunks for the user query and the descriptive paths for the data chunks included in the respective data sources to the context block;
processing an initial input comprising the user query and the initialized context block using a generative neural network to generate an initial output that comprises a sequence of tokens that represent one or more calls to respective paging operations, wherein each paging operation updates one or more data chunks included in the context block and is parameterized by a respective descriptive path;
updating the context block by executing the one or more calls to the respective paging operations;
processing an updated input that includes the updated context block using the generative neural network to generate a final response to the user query; and
outputting the final response to the user query.

2. The method of claim 1, wherein processing the updated input that includes the updated context block using the generative neural network to generate a final response to the user query comprises performing one or more additional updates of the context block by executing the one or more paging operations.

3. The method of claim 1, wherein the one or more paging operations comprise a page-in operation that adds an additional data chunk into the context block, wherein the page-in operation is parameterized by a descriptive path for the data chunk.

4. The method of claim 1, wherein the initial input to the generative neural network comprises a reasoning prompt that causes the generative neural network to include the data specifying the one or more paging operations.

5. The method of claim 1, wherein the one or more paging operations comprise a page-out operation that removes a data chunk from the context block, wherein the page-out operation is parameterized by a descriptive path for the data chunk.

6. The method of claim 1, wherein the descriptive paths for the plurality of data chunks included in the respective data source comprise descriptive paths for each data chunk included in the respective data source.

7. The method of claim 1, wherein the descriptive paths for the plurality of data chunks included in the respective data source comprise descriptive paths for a strict subset of data chunks included in the respective data source.

8. The method of claim 7, wherein the one or more paging operations comprise an expand operation that is parameterized by a descriptive path for a data chunk, wherein execution of the expand operation outputs candidate continuations of the descriptive path.

9. The method of claim 7, wherein the one or more paging operations comprise a toggle operation that is parameterized by a descriptive path for a data chunk, wherein execution of the toggle operation removes content of the data chunk from the context block and retains a description of the data chunk in the descriptive path.

10. The method of claim 1, wherein retrieving the multiple data chunks for the user query comprises retrieving data chunks that are semantically similar to or aligned with the user query.

11. The method of claim 1, wherein descriptive paths for a plurality of data chunks included in a respective data source specify a hierarchical structure of the respective data source.

12. The method of claim 1, wherein a descriptive path for a data chunk included in a respective data source comprises a navigation path for the data chunk and a description of the data chunk, wherein a number of tokens included in the description of the data chunk is less than a number of tokens included in the data chunk.

13. The method of claim 1, wherein each descriptive path for a data chunk included in a respective data source is a unique descriptive path.

14. The method of claim 1, further comprising:
maintaining, during the processing of the initial input and updated input, a transcript of executed paging operations; and
removing, based on the transcript of executed paging operations and from the context block, descriptive paths that lead to loops of paging operations or descriptive paths that have been used to execute a page-in operation.

15. The method of claim 1, further comprising:
maintaining, during the processing of the initial input and updated input, a transcript of executed paging operations; and
bypassing execution of output paging operations that reference descriptive paths that lead to loops of paging operations or descriptive paths that have been used to execute a page-in operation.

16. The method of claim 1, further comprising training the generative neural network using reinforcement learning on labeled training data to utilize the one or more paging operations when processing a user query and context block, wherein the generative neural network is trained to maximize a reward that comprises utility and computational efficiency.

17. The method of claim 16, wherein computational efficiency is measured using one or more of: a number of tokens included in the context block or a number of utilized paging operations.

18. The method of claim 16, further comprising training the generative neural network to utilize the one or more paging operations when processing a user query and context block using curriculum learning on a set of training examples, wherein the training examples in the set are ordered with increasing complexity.

19. A system comprising one or more computers and one or more storage devices storing instructions that are operable, when executed by the one or more computers, to cause the one or more computers to perform operations comprising:
receiving a user query;
retrieving multiple data chunks for the user query, wherein each data chunk for the user query comprises data from a respective data source;
retrieving, for each respective data source, descriptive paths for a plurality of data chunks included in the respective data source, wherein the data chunks included in the respective data source comprise one or more of the multiple data chunks for the user query and one or more other data chunks;
initializing a context block for the user query, comprising adding the multiple data chunks for the user query and the descriptive paths for the data chunks included in the respective data sources to the context block;
processing an initial input comprising the user query and the initialized context block using a generative neural network to generate an initial output that comprises a sequence of tokens that represent one or more calls to respective paging operations, wherein each paging operation updates one or more data chunks included in the context block and is parameterized by a respective descriptive path;
updating the context block by executing the one or more calls to the respective paging operations;
processing an updated input that includes the updated context block using the generative neural network to generate a final response to the user query; and
outputting the final response to the user query.

20. One or more non-transitory computer storage media encoded with instructions that, when executed by one or more computers, cause the one or more computers to perform operations comprising:
receiving a user query;
retrieving multiple data chunks for the user query, wherein each data chunk for the user query comprises data from a respective data source;
retrieving, for each respective data source, descriptive paths for a plurality of data chunks included in the respective data source, wherein the data chunks included in the respective data source comprise one or more of the multiple data chunks for the user query and one or more other data chunks;
initializing a context block for the user query, comprising adding the multiple data chunks for the user query and the descriptive paths for the data chunks included in the respective data sources to the context block;
processing an initial input comprising the user query and the initialized context block using a generative neural network to generate an initial output that comprises a sequence of tokens that represent one or more calls to respective paging operations, wherein each paging operation updates one or more data chunks included in the context block and is parameterized by a respective descriptive path;
updating the context block by executing the one or more calls to the respective paging operations;
processing an updated input that includes the updated context block using the generative neural network to generate a final response to the user query; and
outputting the final response to the user query.
